(19) United States
(12) Patent Application Publication
(10) Pub. No.: US 2023/0137880 A1
(43) Pub. Date: May 4, 2023

(54) METHOD FOR OPERATING A BRAKE SYSTEM OF A MOTOR VEHICLE

(71) Applicant: ZF Active Safety GmbH, Koblenz (DE)

(72) Inventors: Andreas Hoehn, Dreikirchen (DE); Toni Streit, Waldbrunn (DE)

(21) Appl. No.: 17/980,842

(22) Filed: Nov. 4, 2022

(30) Foreign Application Priority Data
Nov. 4, 2021 (DE) 102021128765.0

(51) Int. Cl. B60T 8/1755; B60T 7/12

(52) U.S. Cl. CPC B60T 8/17554; B60T 7/12; B60T 2220/03; B60T 2230/03; B60T 2240/00; B60T 2240/06; B60T 2250/00; B60T 2250/03; B60T 2250/04; B60T 2270/30

(57) ABSTRACT

A method for operating a brake system of an at least double-tracked motor vehicle comprises two breakable wheels, which are arranged at opposite ends of an axle, and a rollover protection system which can cause braking of the wheels in order to prevent a rollover situation. Automatic braking of that wheel of the axle which is loaded more greatly when cornering is brought about by way of the rollover protection system. Subsequently, a smaller steering lock angle or a lower lateral acceleration than in the case of the cornering which took place immediately previously, or a straightahead driving phase which immediately follows the cornering is detected. Thereupon, automatic braking of the two wheels on the axle is brought about.

### CROSS-REFERENCE TO RELATED APPLICATION

This application claims priority to German Priority Application No. 102021128765.0, filed Nov. 4, 2021, the disclosure of which is incorporated herein by reference in its entirety.

### TECHNICAL FIELD

The disclosure relates to a method for operating a brake system of an at least double-track motor vehicle.

### BACKGROUND

The brake systems of modern motor vehicles cooperate with a multiplicity of open-loop and closed-loop control systems in the vehicle which intervene in the normal operation of the vehicle in a manner which is dependent on the driving situation, and cause an actuation of the brakes of individual wheels of the motor vehicle automatically, that is to say independently of the actions of the vehicle driver, and therefore perform automated brake interventions.

Here, for example, an anti-lock braking system (ABS) is to be mentioned which prevents blocking of the wheels during braking, and a traction control system (ASR), by way of which spinning of the wheels is avoided.

It is nowadays also customary to provide an electronic driver assistance system which is intended to counteract swerving of the motor vehicle by way of braking of individual wheels and is often called ESP. This system prevents oversteer of the motor vehicle, for example by way of the respective front wheel on the outside of the corner being braked, whereas understeer is corrected by way of the respective rear wheel on the inside of the corner being braked.

A rollover protection system is known as a further assistance system which detects indications for imminent lateral tilting of the motor vehicle and actively prevents a rollover of the motor vehicle by throttling and braking individual wheels. This system rule activated when a possible imminent rollover situation is detected and brakes the wheel with the greatest loading, as a rule the outer front wheel. In addition, the outer rear wheel can also be braked.

Within the context of this application, open-loop and closed-loop control systems which provide active safety, are considered to be parts of a general driving dynamics system which communicate among one another.

The data, on the basis of which systems of this type make their decisions, are supplied by sensors in the motor vehicle which detect the respective variables.

### SUMMARY

What is needed is to improve automated brake operations by way of an abovementioned rollover protection system.

A method for operating a brake system of an at least double-track motor vehicle is disclosed herein which comprises two brakable wheels, which are arranged at opposite ends of an axle, and a rollover protection system which can cause braking of the wheels in order to prevent a rollover situation. To this end, the following steps are carried out:
a) causing an automatic braking of that wheel of the axle which is loaded more greatly when cornering by way of the rollover protection system, and subsequently,
b) detecting a smaller steering lock angle or a lower lateral acceleration than in the case of the cornering which took place immediately previously, or detecting a straightahead driving phase which immediately follows the cornering, [0013] and, thereupon,
c) causing an automatic braking of the two wheels on the axle.

A driving situation, in which braking of the two wheels does not have a negative influence on the stability of the motor vehicle, can thus be utilized to dissipate kinetic energy of the motor vehicle.

In one exemplary arrangement, the short straightahead driving phase which fundamentally results during a directional change when cornering is suitable to this end.

Here, an ABS system can of course act in an assisting manner if the vehicle speed is to be reduced as greatly as possible.

A driving situation of this type can occur, for example, when changing lane or in general in the case of two following corners with an opposed curvature, or else in the case of a swerving movement.

For example, it is determined during step b) or between steps b) and c) to what extent, as a result of the change in the steering angle after the cornering, the motor vehicle yaws in the opposite direction about its longitudinal direction, and the two wheels are braked in a manner which is dependent thereon.

The axle with the braked wheels may be a front axle of the motor vehicle. It is also conceivable, however, for all the wheels on all the axles to be braked during a driving situation of this type if a particularly large quantity of kinetic energy is to be dissipated.

The extent and/or the time of the braking of the two wheels in step c) can be selected in a manner which is dependent on determined values. Current sensor values can be taken into consideration here, or else stored data. In some driving situations, light braking of the wheel which is loaded less greatly can be sufficient to stabilize the vehicle again, whereas it is necessary another driving situations for the two wheels or possibly all the wheels of the motor vehicle to be braked with a maximum possible brake force, in order to reduce the kinetic energy of the vehicle to such an extent that a rollover situation can be avoided. The decision about the requested brake force, the time and the duration is made, for example, by the rollover protection system or generally the driving dynamics system.

In order to detect a suitable time for braking the two wheels of the axle, a steering wheel angle, a wheel lock angle, a yaw rate of the motor vehicle, a roll angle of the motor vehicle, a vehicle speed and/or a lateral acceleration of the motor vehicle or another suitable variable or combination of variables, from which a corresponding driving situation can be derived, are detected.

The current values may be provided by the respective sensors in the vehicle.

Limit values for the respective variables which are adapted to the respective specific vehicle and possibly also to current environmental influences are preferably specified for the decision as to whether there is a suitable driving situation for braking the two wheels of an axle.

For example, a change in the algebraic sign of the lateral acceleration, a yaw angle or a roll angle, the detection of a counter-steering movement and/or the detection of a change in the wheel which is loaded more greatly are indicators for a brief phase of straightahead driving, in which the two wheels can be braked without problems, and can be taken into consideration in the decision to brake the two wheels of the axle.

The double-sided braking of the wheels is ended, for example, when a predetermined rise in the lateral acceleration after a change in the algebraic sign or a predefined rise in the yaw rate is detected. At this time, for example, the rollover protection system can change back again to single-sided braking of the wheel which is loaded more greatly, or can end the entire brake operation.

The decision about the suitable time to brake the two wheels of the axle can be made, for example, with the aid of a finite state machine, via which the chronological sequence can also be mapped.

In addition, in a driving situation with cornering, a counter-steering movement can be detected by way of a predefined steering angle change being exceeded in a predefined time period in the direction counter to the cornering direction, and, thereupon, the build-up of a brake force can be caused at the opposite wheel which is loaded less greatly by way of the rollover protection system.

This procedure corresponds to the situation of hard counter-steering in a corner or a swerving movement, in the case of which the counter-steering movement causes an impending rollover situation to be expected in the case of the directly imminent loading of the wheel which has previously been loaded to a lesser extent on the current inner side of the corner. Therefore, the rollover protection system already proactively causes the build-up of a brake force at the brake of this wheel at this time, although the wheel load at this wheel at this time is still relatively low. In this way, this wheel is already braked before it becomes the wheel which is loaded more greatly. The brake effect therefore starts at an earlier time, which leads to improved stabilization of the vehicle.

Since the gradient of the brake force build-up is limited by the capacity of the brake system, for example the power output of a pump and a hydraulic system or a mechanical drive, a higher maximum brake force can thus be generated by way of a longer lead time than if the build-up of the brake force begins only when the rollover protection system requires breaking of this wheel as standard at the time when it becomes the wheel which is loaded more greatly.

The wheel which is initially loaded more greatly can be braked further after it has become the wheel which is loaded to a lesser extent, until a predefined value of a lateral acceleration or yaw rate is detected, if kinetic energy of the vehicle is to be dissipated.

In order to avoid abrupt braking manoeuvres, a brake force request which is specified by the rollover protection system for the wheel which is loaded to a lesser extent is initially increased steadily and, as soon as this wheel becomes the wheel which is loaded more greatly, is increased rapidly. Since the brake force for the new wheel which is loaded more greatly does not begin at zero, but rather at the brake force value which has already been reached up to the time of the load change, a higher maximum brake force can be achieved, in particular, than if the build-up of the brake force began only at the low change.

In general, as is known, a model of the driving dynamics of the vehicle may be stored in the driving dynamics system, with the result that the driving dynamics system knows the vehicle behaviour in certain driving situations and also fundamental vehicle data such as the centre of gravity and the wheelbase. These data are supplemented, for example, by current values which are supplied by the various sensors in the vehicle.

The rollover protection system is designed, as is known, in such a way that that wheel of the axle which is loaded more greatly is always braked in the case of an impending rollover situation.

The brake system is generally designed in such a way that the brake force can be specified for each wheel individually and differently with regard to time, duration and magnitude.

In one exemplary arrangement, the wheels which are braked by the rollover protection system are the front wheels, and the axle is a front axle of the motor vehicle. It is optionally also possible for the braking of wheels on a rear axle of the motor vehicle to be caused by way of the rollover protection system in addition or as an alternative.

In one exemplary arrangement, all the described method steps are carried out exclusively in driving situations, in which the rollover protection system is already active in its standard function, that is to say when an impending rollover situation has been detected.

It is fundamentally possible for the described rollover protection system to be used together with one or more autonomously operating assistance systems, for example an emergency steering assistance system, by which the current driving situation is handled without the influence of a human vehicle driver. The assistance systems can also generally communicate with the driving dynamics system.

An electronic open-loop and/or closed-loop control unit may be used as rollover protection system which can be realised, for example, as an independent electronic unit or in an integrated manner in other vehicle systems, for example the driving dynamics system.

### BRIEF DESCRIPTION OF DRAWINGS

In the following text, the disclosure will be described in greater detail on the basis of one exemplary arrangement with reference to the appended figures, in which:

FIG. 1 shows a diagrammatic illustration of a motor vehicle with a brake system for carrying out a method according to the disclosure,

FIG. 2 shows a diagrammatic illustration of driving situations, in which the method according to the disclosure can be applied,

FIG. 3 shows a diagrammatic illustration of a brake force profile in accordance with a situation from FIG. 2,

FIG. 4 shows a fundamental sequence of method steps of a method according to the disclosure,

FIG. 5 shows a diagrammatic illustration of a brake force profile of a situation from FIG. 2,

FIG. 6 shows a fundamental sequence of method steps of a method according to the disclosure, and

FIG. 7 shows a further diagrammatic illustration of a brake profile in accordance with a method according to the disclosure.

### DETAILED DESCRIPTION

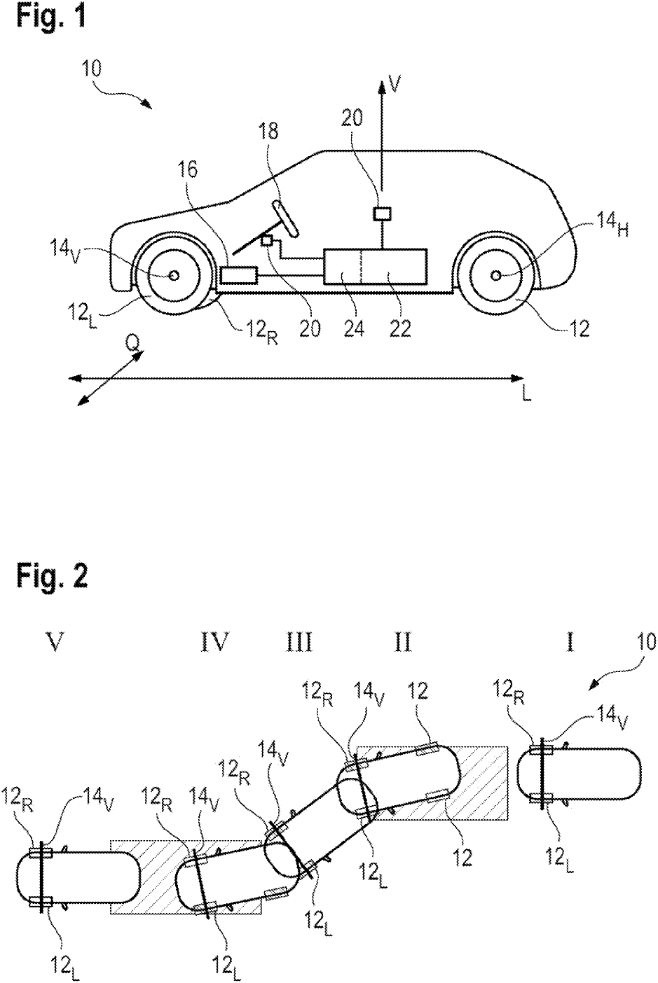

FIG. 1 shows a double-track motor vehicle 10 (here, a passenger car) with a total of four wheels 12 which are arranged on two axles 14 in such a way that in each case two wheels 12 are arranged at opposite ends of an axle 14. The axles 14 extend along a transverse direction Q of the motor vehicle 10, which transverse direction Q lies perpendicularly with respect to a longitudinal direction L.

One of the axles 14 is a front axle 14_{V}, the two wheels 12 on this axle accordingly also being called a left-hand and right-hand front wheel 12_{L}, 12_{R}. The other axle 14 is a rear axle 14_{H} which supports the other two wheels 12.

In this example, all the wheels 12 can be braked independently and individually by way of a brake system 16 which is indicated in FIG. 1, it being possible for the time, duration and brake force F to be selected in a situation-dependent manner and individually for each wheel 12.

The brake system 16 can be of hydraulic design, electromechanical design, or can be designed in a combination including hydraulic and electromechanical components.

Here, the driving direction of the motor vehicle 10 can be influenced via a steering wheel 18 which can be actuated by a vehicle driver.

As an alternative or in addition, it is also conceivable that the steering movement is taken over by an assistance system (not shown), or the motor vehicle 10 is generally designed for autonomous driving.

Various known sensors 20 and the motor vehicle 10 detect current values for suitable variables such as, for example, a steering wheel angle, a wheel lock angle, a vehicle speed, a yaw rate and a roll angle about a vertical axis V the of the motor vehicle 10, a transverse acceleration and similar variables, and possibly also data relating to the surrounding area of the motor vehicle 10.

The sensors 20 are connected to a general driving dynamics system 22, in which various active safety systems of the motor vehicle 10 are combined here, and in which a vehicle model is stored which allows predictions about how the motor vehicle 10 will behave in certain driving situations.

Moreover, there is a rollover protection system 24 which is designed here as part of the driving dynamics system 22 and which is designed to detect potential rollover situations and to take measures to prevent them. To this end, the rollover protection system 24 can fundamentally carry out the standardized procedure that, in the case of detection of a critical driving situation, it causes the wheel which is loaded more greatly of the two wheels 12 on the front axle 14_{V} and possibly also the wheel which is loaded more greatly of the two wheels 12 on the rear axle 14_{H} to be braked in an automated manner with a relatively high brake force F, in order to stabilize the motor vehicle 10 again. The respective brake requests are fulfilled by the brake system 16.

Both the driving dynamics system 22 and the rollover protection system 24 are realised here as purely electronic systems. They can be combined in a single electronics unit, or can be installed on a plurality of separate units in the motor vehicle 10.

FIG. 2 shows a driving situation in steps I to V, in which, coming from the right, the motor vehicle 10 turns into a left-hand corner and describes a right-hand corner after a brief straightahead driving phase.

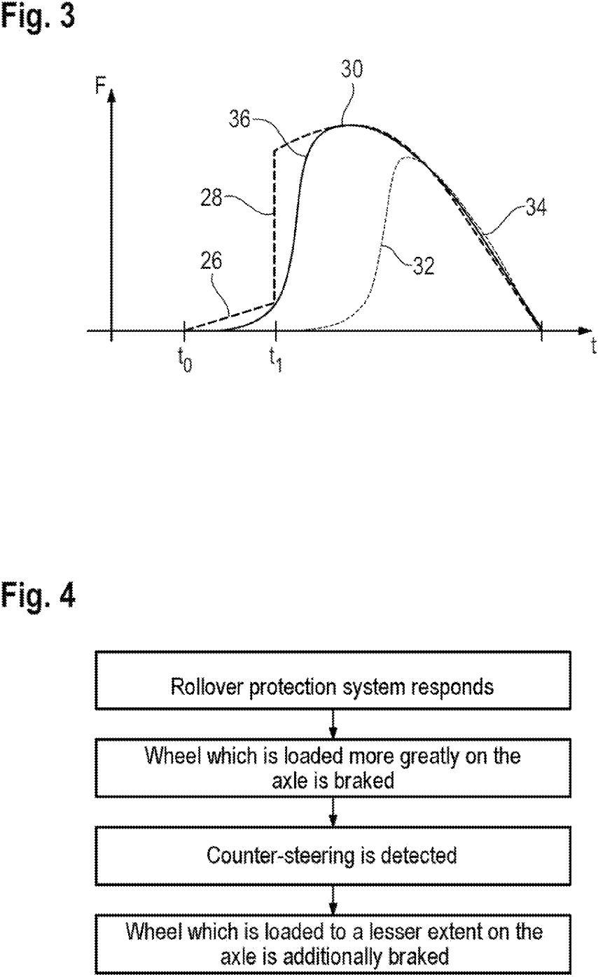

FIG. 3 shows the profile of the brake force F for the left-hand front wheel 12_{L} in FIG. 2 during the left-hand corner.

FIG. 4 shows the fundamental procedure of a method to brake the motor vehicle 10 while driving around the left-hand corner.

The speed of the motor vehicle 10 and the curvature radius of the corner are such, in this example, that the rollover protection system 24 responds at the entry into the corner and already causes the front wheel 12_{R} which is on the outside of the corner and is loaded to a more pronounced extent on the front axle 14_{V} and, in this example, also the rear wheel 12 which is on the outside of the bend and is loaded more greatly on the rear axle to be braked (sections I and II in FIG. 2).

The braked wheels are those on the right side in the second from the left image, the two rear wheels in the third from the left image and the right side wheels in the fourth from left image in FIG. 2.

In this situation, a violent counter-steering movement is detected, in the case of which a predefined steering angle change is exceeded in a predefined time period in the direction counter to the current corner direction. The predefined steering angle change in the predefined time period are selected in such a way, for example in general by the driving dynamics system 22, that a continuation of the risk of a rollover situation is to be expected if they are exceeded in the given conditions.

In order to assess the situation, current sensor values for the vehicle lateral acceleration, the vehicle speed, the roll angle and/or the yaw rate of the motor vehicle 10 are also used here, for which respective predefined values are likewise defined.

The predefined values can in general vary, for example, in a manner which is dependent on the driving situation, possibly also on the ambient conditions or loading of the vehicle. Values of this type are stored, for example, in the driving dynamics model of the driving dynamics system 22.

As a consequence of the detected counter-steering movement, in addition to the right-hand front wheel 12_{R} on the outside of the bend which is loaded more greatly and has already been braked up to now, the rollover protection system 24 causes the opposite front wheel 12_{L} which is on the inside of the corner and is currently loaded to a lesser extent to be braked (see section III in FIG. 2 and time to in FIG. 3).

As FIG. 3 illustrates, the brake force F is built up constantly here, starting from zero, with a relatively low gradient (see curve section 26).

As a result, the left-hand front wheel 12_{L} is already braked from this time to with a small but rising brake force F.

At time t₁ in FIG. 3, the motor vehicle 10 has then moved counter to the first corner direction to such an extent that the load distribution changes, and the left-hand front wheel 12_{L} which is on the inside of the corner and was previously loaded to a lesser extent then becomes the wheel on the outside of the corner which is loaded more greatly (see section IV in FIG. 2). As FIG. 3 shows, the brake force request is then increased rapidly to just below the maximum value, which corresponds to the standard request of the rollover protection system 24 for the wheel which is loaded to a lesser extent (see curve section 28 in FIG. 3).

Since, however, the brake force F for the left-hand front wheel 12_{L} has already risen to a value which is different from zero, the maximum brake force is reached at an earlier time and also assumes a higher value than would be the case if the wheel 12_{L} were braked only from time t₁ in accordance with the standard of the rollover protection system 24 (see curve section 30 in FIG. 3 compared with the dashed line 32 in FIG. 3).

From time t₁, the right-hand front wheel 12_{R} which is then on the inside of the corner is no longer braked, since no further counter-steering movement has been detected or predicted in this example (section IV in FIG. 2).

Section V in FIG. 2 represents the situation, in which the motor vehicle 10 again moves during normal operation and a risk of a rollover is no longer predicted. The rollover protection system 24 accordingly at this time deactivates the braking operations on all the wheels 12, this taking place with a rapidly but constantly decreasing brake force F, as the curve section 34 in FIG. 3 shows.

The continuous line 36 in each case shows the actual profile of the brake force F at the respective wheel 12.

In another variant, FIG. 2 depicts the planned passing through of an S-shaped corner which is composed of a left-hand corner with a directly following right-hand corner. A driving situation of this type corresponds, for example, to a lane change.

In this situation, a steering assistance system can optionally have taken over vehicle steering, which steering assistance system has a suitable image of the surrounding area of the motor vehicle 10 available and which provides a prediction for the entire corner course which already comprises the planned counter-steering and the load change between the from wheels 12_{L}, 12_{R}.

The description of the driving situation is possible, for example, in a known way via a finite state machine which depicts all the states which the brake system 16 can assume for a situation of this type, and the possible state changes which lead to the states. A finite state machine of this type can form the basis of the software in the rollover protection system 24.

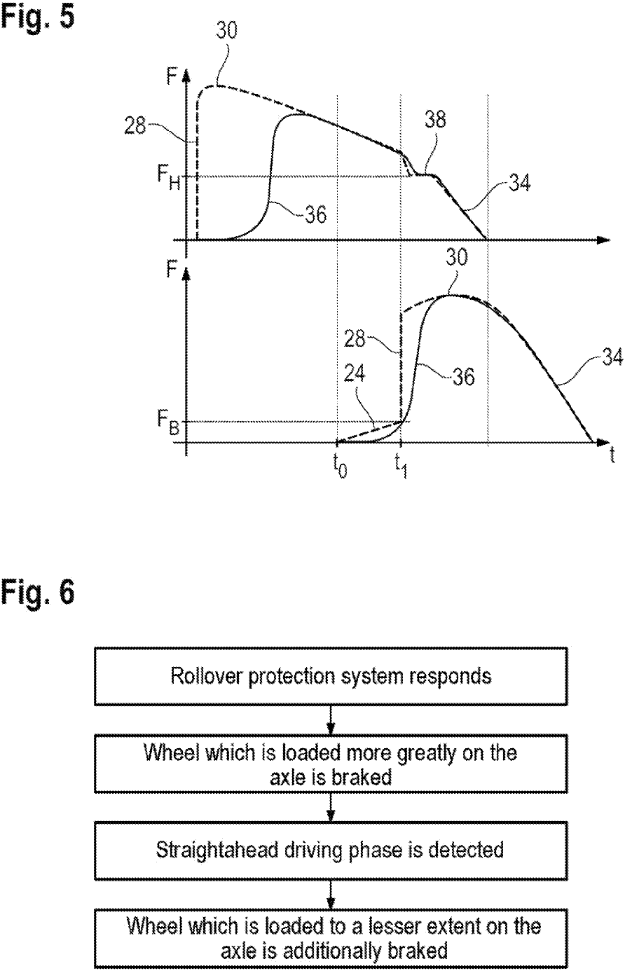

The upper curve in FIG. 5 shows the brake force profile for the right-hand front wheel 12_{R} which is on the outside of the corner at the beginning, while the lower curve describes the left-hand front wheel 12_{L} which is on the inside of the corner at the beginning.

In this example, a potential rollover situation is detected at the beginning of the first steering movement into the left-hand corner, and the rollover protection system 24 causes breaking of the right-hand front wheel 12_{R} which is on the outside of the corner and, in this example, also of the rear wheel 12 which is on the outside of the corner.

To this end, the brake force request which is caused by the rollover protection system 24 is set suddenly to just under the maximum possible value and is then increased steeply but constantly to the maximum value (see curve sections 28, 30 in FIG. 5 at the top).

The brake force F which actually prevails at the respective wheel 12_{L}, 12_{R} follows the specification of the curve sections 28, 30 (see in each case curve 36) with a corresponding time delay.

The left-hand front wheel 12_{L} is not yet braked at this time.

Since the left-hand corner is followed by a right-hand corner, a reversal of the corner curvature necessarily takes place which is associated with a brief straightahead driving phase (see section III in FIG. 2). During this directional change of the steering movement, in a phase with a low lateral acceleration, a small yaw angle and/or a small roll angle, the rollover protection system 24 causes the two wheels 12_{L}, 12_{R} on the front axle 14_{V} to be braked, that is to say the left-hand front wheel 12_{L} which is currently loaded to a lesser extent to also be braked in addition to the right-hand front wheel 12_{R} are which is already braked.

In FIG. 5, this begins at time t₀, the brake force F being increased with a considerably smaller gradient than in section 28 of the curve to a value F_{B} below the maximum brake force value (see curve section 26 in FIG. 5 at the bottom). Since only a slow rise in the brake force F is specified, the actually produced brake force F can follow this specification relatively promptly (see curve 36).

In this straightahead driving phase, the two front wheels 12_{L}, 12_{R} are therefore braked, part of the kinetic energy of the motor vehicle 10 being dissipated. It would also be conceivable to increase the brake force F here rapidly to a higher value, in order to dissipate a maximum amount of kinetic energy of the motor vehicle 10 in this phase. The two wheels 12 of the rear axle 14_{H} might likewise be braked.

At time t₁, the effects of the counter-steering in the following corner section which is curved in an opposite direction can be seen, and a load change takes place for the left-hand front wheel 12_{L} which has up to now been loaded to a lesser extent and now becomes the wheel which is loaded more greatly. For this reason, the standard setting of the rollover protection system 24 also engages again at this time to brake the wheel which is loaded more greatly to a maximum possible extent, for which reason a sudden rise in the brake force F is requested (see curve section 28, 30 in FIG. 5 and section IV in FIG. 2).

At the same time, the brake force F at the right-hand front wheel 12_{R} which is then loaded to a lesser extent is reduced.

Since, however, the motor vehicle 10 is still situated in a (relative) straightahead driving state, the rollover protection system 24 causes the brake force F to be held at a middle level F_{H} (see curve section 38) and therefore to still brake the two wheels 12_{L}, 12_{R}.

For example, a reduction and, moreover, an algebraic sign change of the lateral acceleration and/or the roll angle, a detection of a counter-steering movement and/or a detection of the change in the front wheel 12_{L}, 12_{R} which is loaded more greatly are used to detect the beginning and the end of that phase of straightahead driving.

Here, the double-sided braking of the front wheels 12_{L}, 12_{R} is ended, for example, when a rise in the lateral acceleration after an algebraic sign change or arise in the yaw rate or the roll angle beyond a predefined limit value is detected.

The fundamental sequence of this method is shown in FIG. 6.

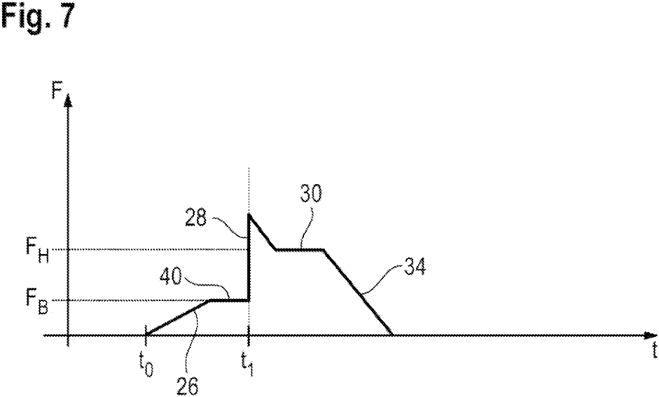

FIG. 7 shows an exemplary profile for the request of the brake force F by way of the rollover protection system 24.

At time t₀, the wheel 12 which is loaded to a lesser extent is braked, the brake force F being requested with a small, constant gradient in the curve section 26. The brake force F which is requested in this phase is limited to a maximum value F_{B} which is considerably smaller than the maximum possible brake force value. If no load change of the wheels takes place, the brake force F is held at the level F_{B}. This is shown by the curve section 40.

Here, a load change occurs at time t₁, with the result that the wheel which has up to this time been loaded to a lesser extent then becomes the wheel which is loaded to a greater extent on the axle 14 under consideration. Accordingly, the rollover protection system 24 requests a sudden increase in the brake force F (curve section 28) as far as a considerably higher maximum value than the value F_{B}.

As a rule, only a relatively short brake pulse is set by way of this maximum value, with the result that the brake force request is rapidly reduced again.

In this case, however, a straightahead driving phase is still detected (the rollover protection system 24 also at the same time detecting a danger position), with the result that the wheel which is now loaded more greatly is braked further with a brake force request F_{H}, in order to continue to brake the two wheels 12 on the axle 14. Here, the brake force F_{H} lies between the brake force F_{B} and the maximum brake force (see curve section 38).

At the same time, the opposite wheel 12 (not shown here) which is currently loaded to a lesser extent on the axle 14 is braked at most with the brake force F_{B}.

If the danger situation is over, the brake force request is reduced constantly (see curve section 34).

It is generally possible that the rollover protection system 24 in each case only causes the wheels 12 on the front axle 14_{V} to be braked. It is also conceivable, however, for the wheels 12 on the rear axle 14_{H} to also be braked in addition or as an alternative.

1. A method for operating a brake system of an at least double-track motor vehicle which comprises two brakable wheels, which are arranged at opposite ends of an axle, and a rollover protection system which can cause braking of the wheels in order to prevent a rollover situation, the method comprising the steps of:
a) causing ef-automatic braking of a wheel of the axle which is loaded more greatly when cornering by way of the rollover protection system, and subsequently,
b) detecting a smaller steering lock angle or a lower lateral acceleration than in a case of the-cornering which took place immediately previously, or detecting of a straightahead driving phase which immediately follows the cornering, and, thereupon,
c) causing automatic braking of the two wheels on the axle.

2. The method according to claim 1, wherein it is determined during step b) or between steps b) and c) to what extent, as a result of a change in the steering angle after the cornering, the motor vehicle yaws in an opposite direction about its longitudinal direction, and the two wheels being braked in a manner which is dependent thereon.

3. The method according to claim 1, wherein the axle with the braked wheels being a front axle of the motor vehicle.

4. The method according to claim 1, wherein an extent of the braking of the two wheels in step c) being dependent on determined values.

5. The method according to claim 1, wherein a steering wheel angle, a wheel lock angle, a yaw rate of the motor vehicle, a roll angle of the motor vehicle, a vehicle speed and/or a lateral acceleration of the motor vehicle are determined.

6. The method according to claim 5, wherein a change in an algebraic sign of the lateral acceleration, the yaw angle or the roll angle, the detection of a counter-steering movement and/or the detection of a change in the wheel which is loaded more greatly taken into consideration in causing braking of the two wheels.

7. The method according to claim 5, wherein a double-sided braking of the wheels is ended when a predetermined rise in the lateral acceleration after a change in an algebraic sign or a predefined rise in the yaw rate is detected.

8. The method according to claim 1, further comprising the step of:
detecting a counter-steering movement by way of a steering angle change being exceeded in a predefined time period in a direction counter to a cornering direction, and, thereupon,
causing ef-a brake force to be built up at an opposite wheel which is loaded less greatly by way of the rollover protection system.

9. The method according to claim 8, wherein the wheel which is initially loaded more greatly is braked further after such wheel has become the wheel which is loaded less greatly, until a predefined value of a lateral acceleration or yaw rate is detected.

10. The method according to claim 1, wherein a brake force request which is specified by the rollover protection system for the wheel which is loaded less greatly initially being increased steadily and, as soon as such wheel becomes the wheel which is loaded more greatly, being increased rapidly.

11. The method according to claim 1, wherein the axle with the braked wheels is a front axle of the motor vehicle.

12. The method according to claim 2, wherein an extent of the braking of the two wheels in step c) being dependent on determined values.

13. The method according to claim 2, wherein a steering wheel angle, a wheel lock angle, a yaw rate of the motor vehicle, a roll angle of the motor vehicle, a vehicle speed and/or a lateral acceleration of the motor vehicle are determined.

14. The method according to claim 6, wherein a double-sided braking of the wheels is ended when a predetermined rise in the lateral acceleration after a change in the algebraic sign or a predefined rise in the yaw rate is detected.

15. The method according to claim 5, further comprising the step of:
detecting a counter-steering movement by way of a steering angle change being exceeded in a predefined time period in a direction counter to a cornering direction, and, thereupon,
causing a brake force to be built up at an opposite wheel which is loaded less greatly by way of the rollover protection system.

16. The method according to claim 15, wherein the wheel which is initially loaded more greatly is braked further after such wheel has become the wheel which is loaded less greatly, until a predefined value of a lateral acceleration or yaw rate is detected.

17. The method according to claim 16, wherein a brake force request which is specified by the rollover protection system for the wheel which is loaded less greatly initially being increased steadily and, as soon as such wheel becomes the wheel which is loaded more greatly, being increased rapidly.
